(19) United States
(12) Patent Application Publication
(10) Pub. No.: US 2026/0088365 A1
(43) Pub. Date: Mar. 26, 2026

(54) SURFACE AREA INCREASE AND PROTECTION FOR ELECTRODES

(71) Applicant: Apple Inc., Cupertino, CA (US)

(72) Inventors: Tingting Zhang, Campbell, CA (US); Enbang Wang, San Lorenzo, CA (US); Hanfang Chen, Changzhou (CN); Wei Kah Tan, Campbell, CA (US); Daeshin Lee, San Jose, CA (US); Mark E. Wilcox, Morgan Hill, CA (US); Atish S. Patankar, Foster City, CA (US); Rajesh Kandibanda, Menlo Park, CA (US); Joshua M. Chien, Portola Valley, CA (US); Erik D. Gillow, Redwood City, CA (US); He Li, Beijing (CN); Ee Min Lim, Shanghai (CN)

(73) Assignee: Apple Inc., Cupertino, CA (US)

(21) Appl. No.: 19/334,423

(22) Filed: Sep. 19, 2025

Related U.S. Application Data
(60) Provisional application No. 63/698,532, filed on Sep. 24, 2024.

(51) Int. Cl. H01M 10/0585; H01M 4/02; H01M 4/04; H01M 4/583

(52) U.S. Cl. CPC H01M 10/0585; H01M 4/0435; H01M 4/583; H01M 2004/021; H01M 2004/027; H01M 2200/00

(57) ABSTRACT

Batteries that can have improved power delivery capabilities. One example can provide an anode electrode having an increased surface area. This increase in surface area can improve electrolyte wetting capability and lithium ion diffusion kinetics. The improved electrolyte wetting capability and lithium ion diffusion kinetics can enable better cell charge and discharge capabilities and a longer cycle life. The surface area of the anode electrode can be increased by mechanically forming holes, slots, lines, or other patterns in the surface of the anode electrode. A protective layer can be formed on the surface of the anode electrode using spatial atomic layer deposition. The protective layer can be formed of aluminum oxide.

### CROSS-REFERENCES TO RELATED APPLICATIONS

This application claims the benefit of U.S. Provisional Application No. 63/698,532, filed on Sep. 24, 2024, which is incorporated by reference.

### BACKGROUND

The number of types of electronic devices that are commercially available has increased tremendously the past few years and the rate of introduction of new devices shows no signs of abating. Devices such as tablet and laptop computers, cell phones, wearable-computing devices, portable media players, navigation systems, and others, have become ubiquitous.

These devices are often portable such that they can be carried by users. To enable their portability, they typically have a battery that can be charged and used to operate the devices without the need for an external power supply.

The quality and capabilities of the batteries can greatly affect the experience a user can have with these devices. It can be desirable that these batteries can provide power for an extended period. Thus, what is needed are batteries that can have improved power delivery capabilities.

### SUMMARY

Accordingly, embodiments of the present invention can provide batteries that can have improved power delivery capabilities. An illustrative embodiment of the present invention can provide an anode electrode having an increased surface area. This increase in surface area can improve electrolyte wetting capability and lithium ion diffusion kinetics. The improved electrolyte wetting capability and lithium ion diffusion kinetics can enable better cell charge and discharge capabilities and a longer cycle life. The surface area of the anode electrode can be increased by mechanically forming holes, slots, lines, or other patterns in the surface of the anode electrode.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates a battery that can be improved by an embodiment of the present invention;

FIG. 2 illustrates a cross-section of a portion of an anode electrode for a battery that can be improved by an embodiment of the present invention;

FIG. 3 illustrates a cross-section of a portion of an anode electrode for a battery according to an embodiment of the present invention;

FIG. 4 illustrates a method of forming an anode electrode for a battery according to an embodiment of the present invention;

FIG. 5 illustrates a method of forming another anode electrode for a battery according to an embodiment of the present invention;

FIG. 6 illustrates a pin that can be used in forming holes in an anode electrode according to an embodiment of the present invention;

FIG. 7A and FIG. 7B illustrate a cross-section of a hole in an anode electrode for a battery according to an embodiment of the present invention;

FIG. 8A through 8F illustrate top views of hole patterns for anode electrodes for batteries according to an embodiment of the present invention;

FIG. 9 illustrates a top view of another hole pattern for an anode electrode for a battery according to an embodiment of the present invention;

FIG. 10 illustrates a top view of another hole pattern for an anode electrode for a battery according to an embodiment of the present invention;

FIG. 11 illustrates a system for forming holes in a top and bottom of an anode electrode structure for a battery according to an embodiment of the present invention;

FIG. 12 illustrates compression forces being applied to a hole in an anode electrode for a battery according to an embodiment of the present invention;

FIG. 13A and FIG. 13B are top views of a comparison of holes in a top and holes in a bottom of an anode electrode for a battery according to an embodiment of the present invention;

FIG. 14 is a side view of a comparison of holes in a top and holes in a bottom of an anode electrode for a battery according to an embodiment of the present invention; and

FIG. 15 illustrates an improvement in capacity as a function of discharge current for a battery formed according to an embodiment of the present invention.

### DESCRIPTION OF ILLUSTRATIVE EMBODIMENTS

An illustrative embodiment of the present invention can provide an anode electrode having an increased surface area. The increase in surface area can be generated by forming a plurality of holes in a surface of the anode electrode. The surface area of the anode electrode can be increased by mechanically forming holes, slots, lines, or other patterns in the surface of the anode electrode. These holes or other patterns can be mechanically formed by pins or other shaped protrusions extending from a cylinder, where the cylinder can roll over a surface of the anode electrode during manufacturing.

Mechanically increasing the surface area can provide several benefits. For example, this increase in surface area can improve electrolyte wetting capability and lithium ion diffusion kinetics. The improved electrolyte wetting capability and lithium ion diffusion kinetics can enable better cell charge and discharge capabilities, a longer cycle life, and a decrease in capacity fading. The increase in surface area can further improve the capacity, particularly at high charge and discharge rates. The increase surface area can improve electrolyte transport in both capillary driven and concentration driven mechanisms, leading to the electrolyte wetting. Mechanically increasing the surface area can improve cell longevity and reduce cycle swell. Volume energy density can also be improved.

This increase in surface area can also reduce the electrochemical potential. This reduced electrochemical potential can be used to reduce the lithium plating of the anode electrode, it can allow the use of faster charging, or a combination of both.

The use of mechanical drilling in forming these holes or other patterns provides consistent control of hole size and spacing. Mechanical drilling can be performed at a rate of speed that can be similar to calendering for manufacturing efficiency. Mechanical drilling can also provide holes in a surface of an anode electrode without removing material. This is in comparison to other techniques, such as lasering, which can vaporize or oblate material of an anode electrode.

After holes have been formed in a surface of an anode electrode, a protective layer can be deposited on the surface and in the holes. This protective layer can be formed of aluminum oxide or other material. The protective layer can be formed using atomic layer deposition. For example, the protective layer can be formed using spatial atomic layer deposition (SALD.) The protective layer can help to prevent a formation of a solid electrolyte interphase (SEI) layer of the anode, which could otherwise irreversibly consume lithium ions. The protective layer can further help to limit the pulverization of anode particles caused by lithium ion exchange. The protective layer can further reduce dendrite growth from the anode and can reduce particle cracking as well. This or a similar protective layer can be formed on a surface of the cathode as well. This cathode protective layer can also help to prevent particle cracking in the cathode and can reduce structural disorder in the cathode. The cathode protective layer can also help to inhibit transition metal dissolution and pulverization.

These embodiments of the present invention can be used to improve various types of batteries having different form factors. An example of one such battery is shown in the following figure.

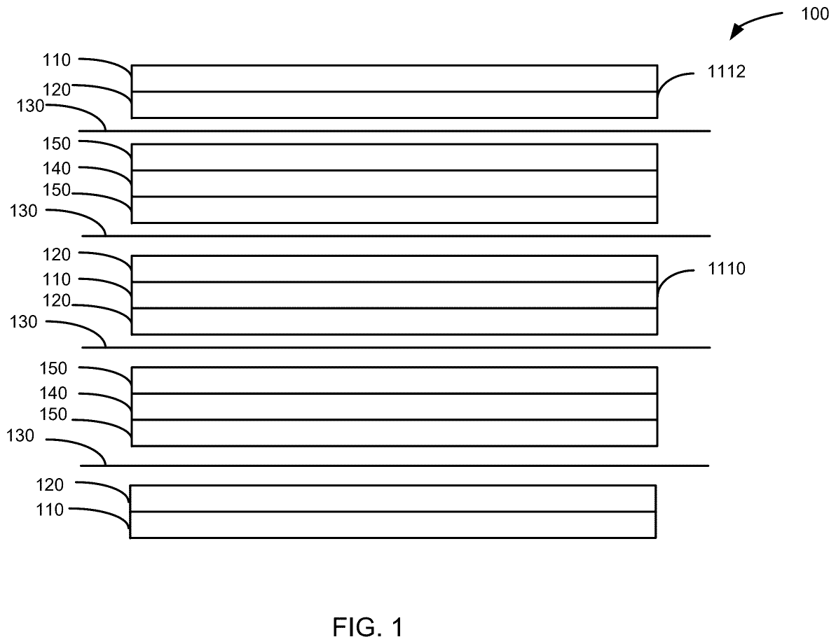

FIG. 1 illustrates a battery that can be improved by an embodiment of the present invention. This figure, as with the other figures, is shown for illustrative purposes and does not limit either the possible embodiments of the present invention or the claims.

Battery 100 can include copper foil anode current collectors 110 supporting anode electrodes 120. Anode electrodes 120 can be formed of graphite or other material. Anode electrode 120 can be separated from cathode electrodes 150 by separator layers 130. Separator layers 130 can allow lithium ions to pass back and forth between cathode electrodes 150 and anode electrodes 120 while blocking the transfer of electrons. Cathode electrodes 150 can be supported by aluminum foil cathode current collectors 140. Anode electrode structure 1110 can include two anode electrodes 120 supported by a copper foil anode current collector 110. Anode electrode structure 1112 can include one anode electrode 120 supported by a copper foil anode current collector 110. While copper foil is shown in these examples as providing an anode current collector 110, other materials can be used for anode current collector 110. Similarly, while aluminum foil is shown in these examples as providing a cathode current collector 140, other materials can be used for cathode current collector 140.

The surface area of one or more anode electrodes 120 can be increased by mechanically forming holes or other patterns in a surface facing a corresponding cathode electrode. This can help with the diffusion of lithium in the anode electrodes 120. An example of this is shown in the following figure. Also, while these embodiments are particularly well-suited to increasing a surface area of an anode electrode, these and other embodiments of the present invention can be used to increase surface areas of cathodes or other battery structures.

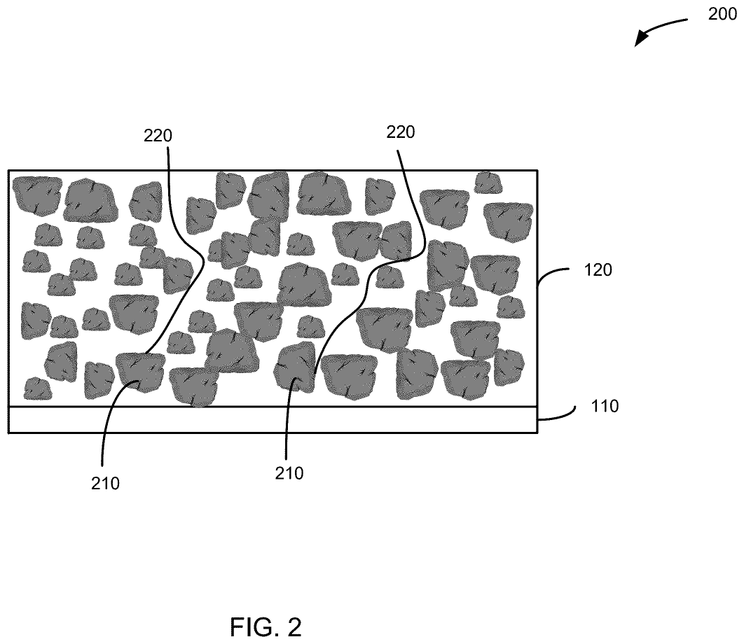

FIG. 2 illustrates a cross-section of a portion of an anode electrode for a battery that can be improved by an embodiment of the present invention. Anode portion 200 can include anode electrode 120 and copper foil anode current collector 110. Anode electrode 120 can be formed of or include particles 210. Particles 210 can be formed of graphite or other materials. Anode electrode 120 can have been calendered and dried such that particles 210 are tightly compacted. This can form tortuous paths for lithium ions 220 to traverse through anode electrode 120, which can cause several problems. For example, the lithium ions 220 can often cease movement near a top surface of anode electrode 120. This can cause the concentration of lithium to be higher near a top surface of anode electrode 120 and lower near a bottom surface adjacent to copper foil anode current collector 110. This higher concentration can lead to lithium plating at the top surface of the anode electrode 120, which can shorten battery life and reduce capacity. Accordingly, embodiments of the present invention can provide additional paths that can help with the diffusion of lithium ions and can increase the surface area of anode electrode 120. An example is shown in the following figure.

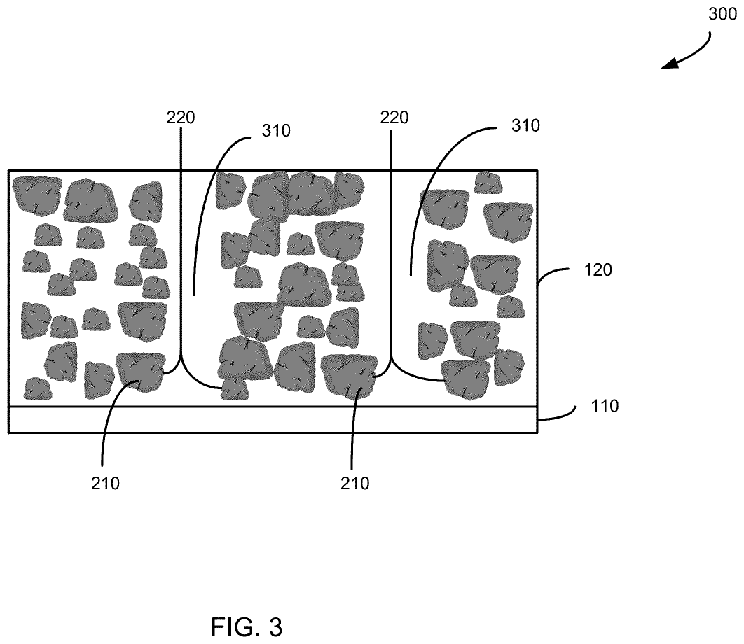

FIG. 3 illustrates a cross-section of a portion of an anode electrode for a battery according to an embodiment of the present invention. Anode portion 300 can include anode electrode 120 and copper foil anode current collector 110. Anode electrode 120 can be formed of or include particles 210. Particles 210 can be formed of graphite or other materials. Anode electrode 120 can have been calendered and dried such that particles 210 are tightly compacted. Holes 310 have been mechanically formed in anode electrode 120. Holes 310 can form paths such that lithium ions 220 can more easily reach particles 210 near copper foil anode current collector 110. This can provide for a more uniform diffusion of lithium ions 220 throughout anode electrode 120. This can help to reduce lithium plating near a top surface of anode electrode 120, thereby helping to decrease capacity fading and increasing cycle life.

The increase surface area can improve electrolyte transport in both capillary driven and concentration driven mechanisms, leading to improved electrolyte wetting. For example, the increased surface area in holes 310 can expose more capillaries to lithium ions 220, thereby improving their diffusion. Also, lithium ions 220 that move due to concentration gradients have easier paths to move through thereby reducing the concentration gradients. Both of these factors can improve electrolyte wetting, thereby improving performance and battery life. The lithium ions also have improved access to particles 210 at various depths of anode electrode 120.

These anode electrodes 120 can be formed in various ways. An example is shown in the following figure. Also, while these embodiments are particularly well-suited to increasing a surface area of an anode electrode, these and other embodiments of the present invention can be used to increase surface areas of cathodes or other battery structures.

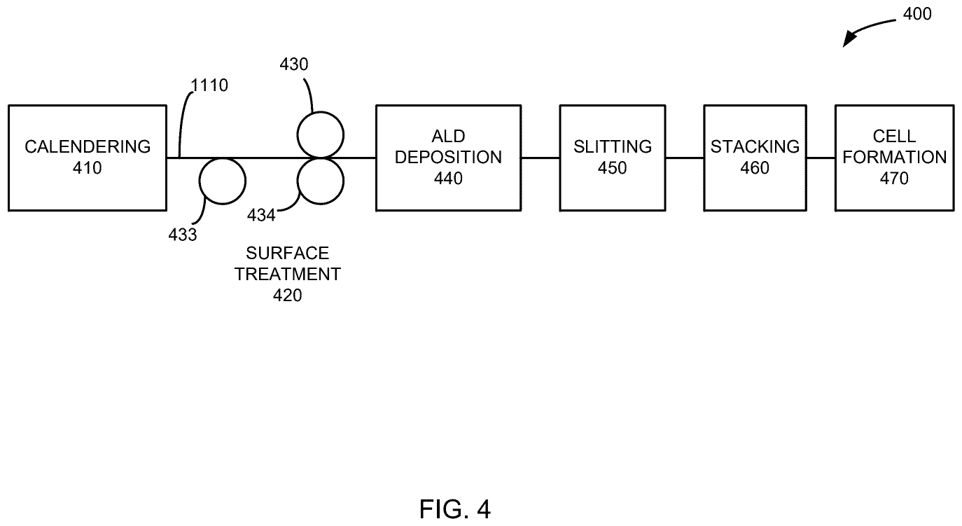

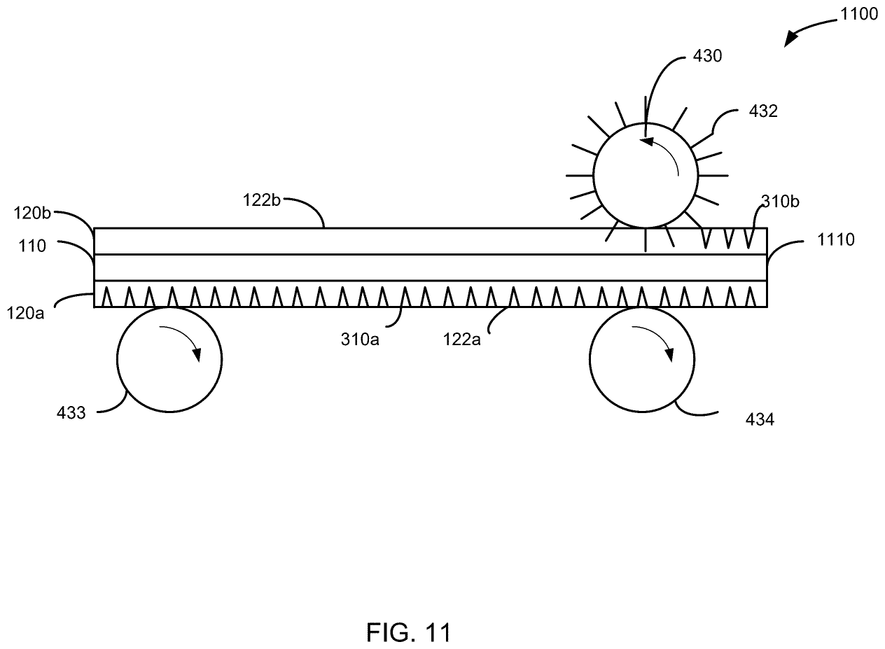

FIG. 4 illustrates a method of forming an anode electrode structure for a battery according to an embodiment of the present invention. Anode electrode structure 1110 can be calendered by calender 410, though in other examples anode electrode structure 1112 can be calendered by calender 410. Calender 410 can compact the anode electrode structure 1110 using one or more rollers that apply pressure to each side of anode electrode structure 1110. The calendered anode electrode structure 1110 can be provided by roller 433 to cylinder 430. Roller 433 can help to guide anode electrode structure 1110 to cylinder 430 and roller 434. Cylinder 430 can include a number of pins 432 (shown in FIG. 11) that can form holes 310 (shown in FIG. 3) in anode electrodes 120 of anode electrode structure 1110 (or 1112). That is, cylinder 430 can roll over the surface of an anode electrode 120 (shown in FIG. 1) as anode electrode structure 1110 (or 1112) passes by, thereby forming holes 310 in one surface of anode electrode structure 1112 or two surfaces of anode electrode structure 1110.

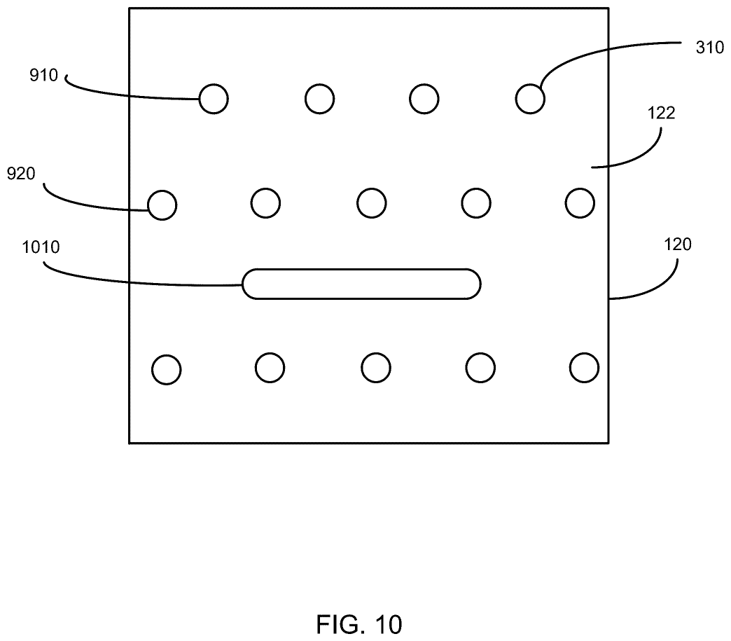

In this example, holes 310 are shown as being formed by pins 432 of cylinder 430. In these and other embodiments of the present invention, other devices, such as a laser, can be used to form additional holes 310 or other depressions having other shapes. For example, a laser can be used to form lines as shown below in FIG. 10. One or more lasers can be used to form other shaped depressions, such as plus signs, X shaped depressions, or other shaped holes or depressions.

Once holes 310 are formed in anode electrode 120, a protective layer can be formed on surfaces of anode electrodes 120 of anode electrode structure 1110 (or 1112) and in holes 310. For example, an atomic layer deposition can be formed on the surface and in the holes of the anode electrodes 120 anode electrode structure using atomic layer deposition machine 440. Atomic layer deposition machine 440 can be a spatial atomic layer deposition machine. In these and other embodiments of the present invention, the protective layer can be formed of aluminum oxide. The protective layer can help to prevent plating of the anode electrodes 120. That is, the protective layer can help to prevent the formation of a solid electrolyte interphase (SEI) layer on anode electrodes 120, which could otherwise irreversibly consume lithium ions. The protective layer can also help to reduce the pulverization of the graphite particles 210 (shown in FIG. 2) caused by volume changes due to lithium ion insertion and extraction. The protective layer can also help to prevent particle cracking and can suppress dendrite growth. Various equipment can be used as atomic layer deposition machine 440. For example, the Genesis ALD is available from Beneq, a division of Beneq Group of Espoo, Finland.

In these and other embodiments of the present invention, the protective layer can be much thinner than a diameter of hole 310. This can allow the inside surface of holes 310 to be coated by the protective layer. For example, the holes can be one or more microns in diameter, ten to 30 microns in diameter, 30 to 60 microns in diameter, 60 to 100 microns in diameter, or greater than 100 microns in diameter. The protective layer can be much thinner, such as five to 50 nanometers, or less than five or greater than 50 nanometers.

Once the protective layer is deposited, the anode electrodes can be slit or cut into shape for use in a battery by slitting machine 450. A stack can be formed by stacker 460. Stacker 460 can form stacks of electrodes, current collectors, and separators as shown by battery 100 in FIG. 1. Once the stacks have been formed, the battery cell formation can be formed by cell formation system 470. This method can be further outlined in the following figure.

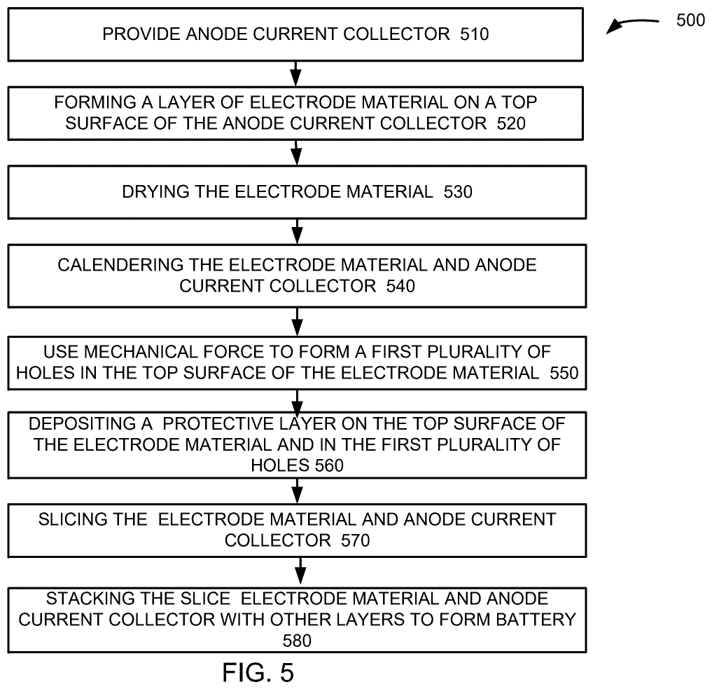

FIG. 5 illustrates a method of forming another anode electrode for a battery according to an embodiment of the present invention. In act 510, an electrode current collector, such as a copper foil layer, can be provided. A first layer of electrode material can be formed on a top surface of the anode current collector in act 520 to form anode electrode structure 1112 (shown in FIG. 1.) Optionally, a second layer of electrode material can be formed on a bottom surface of the anode current collector to form anode electrode structure 1110 (id.) The layer of electrode material can be for an anode electrode, though the electrode material can be for a cathode electrode as well or instead. The layer of electrode material can be graphite or other material. The one or more layers of electrode material can be dried in act 530. In act 540, the one or more layers of electrode material and anode current collector or other anode current collector can be calendered by using one or more rollers. This can work to compress the electrode material. An advantage of this is that the electrode material is compressed thereby increasing the energy density of the battery. A disadvantage is that it makes the path for lithium ions more tortuous, as shown in FIG. 3.

Accordingly, in act 550, holes can be mechanically formed in surfaces of the electrode anode structure that are away from the anode current collector. These holes can provide paths deep into the anode electrode material and can increase the surface area of the anode electrode. This increase in surface area can provide several benefits. For example, this increase in surface area can improve electrolyte wetting capability and lithium ion diffusion kinetics. The improved electrolyte wetting capability and lithium ion diffusion kinetics can enable better cell charge and discharge capabilities and a longer cycle life and decrease in capacity fading. Specifically, the increase surface area can improve electrolyte transport in both capillary driven and concentration driven mechanisms, thereby improving electrolyte wetting.

This increase in surface area can also reduce the electrochemical potential. This reduced electrochemical potential can be used to reduce the lithium plating of the anode electrode, it can allow the use of faster charging, or a combination of both.

The use of mechanical drilling in forming these holes or other patterns provides consistent control of hole size and spacing. Mechanical drilling can be performed at a rate of speed that can be similar to calendering for manufacturing efficiency. Mechanical drilling can also provide holes in a surface of an anode electrode without removing material. This is in comparison to other techniques, such as lasering, which can vaporize or oblate material of an anode electrode.

After holes have been formed in a surface of the electrode material, a protective layer can be deposited on the surface and in the holes in act 560. This protective layer can be formed of aluminum oxide or other material. The protective layer can be formed using atomic layer deposition. For example, the protective layer can be formed using spatial atomic layer deposition. The protective layer can help to prevent plating of the electrode material during use in a battery. That is, the protective layer can help to prevent the formation of a solid electrolyte interphase (SEI) layer on the electrode material, which could otherwise irreversibly consume lithium ions. The protective layer can further help to reduce the pulverization of individual graphite particles in the electrode material caused by volume changes due to lithium ion insertion and extraction during use in a battery. The protective layer can further reduce dendrite growth from the anode and can reduce particle cracking as well. This or a similar protective layer can be formed on a surface of the cathode as well. This cathode protective layer can also help to prevent particle cracking in the cathode and can reduce structural disorder in the cathode. The cathode protective layer can also help to inhibit transition metal dissolution and pulverization.

After a protective layer has been added, the electrode material and anode current collector can be sliced into form factors for use in a battery in act 570. The sliced electrodes can be stacked with other electrodes and separators and a battery can be formed in act 580.

Pin 432 used to form hole 310 can have various shapes and sizes. An example of a pin that can be used is shown in the following figure.

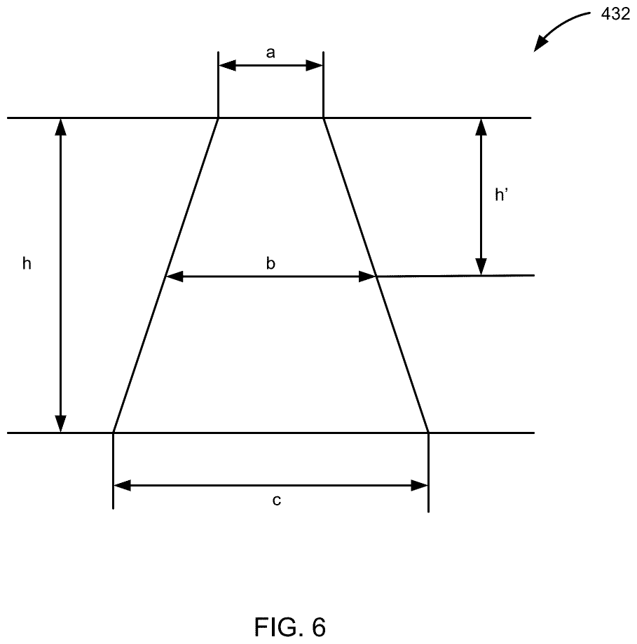

FIG. 6 illustrates a pin that can be used in forming holes in an anode electrode according to an embodiment of the present invention. Pin 432 can be formed on cylinder 430 (shown in FIG. 4.) Pin 432 can have circular horizontal (as drawn) cross section. A top of pin 432 can have a diameter a and a bottom of pin 420 can have a diameter c, where c is the surface that connects to cylinder 430. Pin 432 can have a beam diameter of b and a height of h. The beam can be positioned h′ below a top of pin 432.

These dimensions can have different values. In one example, a can be 4, 5, 10, 20, or more than 20 microns, b can be 14, 17, 20, 26, 39, or more than 39 microns, c can be 25, 30, 35 45, or more than 45 microns, h can be 25, 35, 45, 60, or more than 60 microns, and h′ can be 8, 10, 12, 17, 20, 30, or more than 30 microns. Pins 432 can have a pitch of 40, 47.5, 55, 62.5, or more than 62.5 microns. Pins 432 can have a density of 110, 160, 220, 380, 440, 500, or more than 500 pins per square millimeter.

The mechanically formed holes provided by embodiments of the present invention can have various shapes. An example is shown in the following figure.

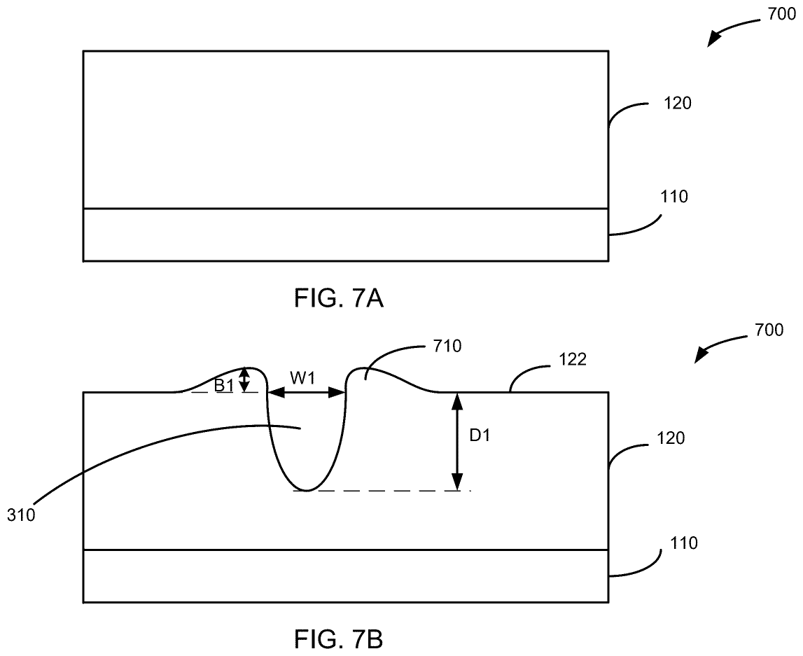

FIG. 7A and FIG. 7B illustrate a cross-section of a hole in an anode electrode for a battery according to an embodiment of the present invention. In FIG. 7A, anode portion 700 can include anode current collector 110 supporting anode electrode 120. In FIG. 7B, hole 310 has been formed in anode electrode 120 in anode portion 700. As hole 310 is mechanically formed by pins 432 (shown in FIG. 11), material 710 can be pushed out of hole 310 and above a top surface 122 of anode electrode 120, thereby increasing a thickness of anode electrode 120. This can be in contrast to laser formed holes which can vaporize or oblate material in anode electrode 120. Anode electrode 120 can be supported by anode current collector 110.

The depth of hole 310 in this example is shown as D1. The width of hole 310 in this example is shown as W1. An increased thickness caused by material 710 being pushed up out of hole 310 and above surface 122 during its formation is shown as B1. These dimensions can vary with the dimensions of pin 432 used to form hole 310 and the mechanical force applied to pin 432 when hole 310 is formed. In these embodiments of the present invention, the applied pressure can be approximately 100, 200, 300, 450, 600, 900, 1200, 1500, 1800, or more than 1800 newtons to an anode electrode having a thickness of approximately 80, 100, 120, 140, 180, 220, or more than 220 microns. Hole 310 can have a depth of approximately 5, 25, 35, 45, 45, 50, or more than 50 microns. Hole 310 can have a width or diameter W1 of approximately 13, 15, 17, 19, 22, 23, 24, or more than 24 microns. The additional thickness B1 can have a height of approximately 1, 6, 7, 8, 9, or more than 9 microns.

Holes 310 can be formed having various patterns across surface 122 of anode electrode 120. These patterns can be consistent across surface 122, or they can be at least somewhat randomized. Also, along with circular holes, holes or depressions having other shapes can be used. For example, lines, plus signs, “X” patterns, or other shapes can be used. Examples are shown in the following figures.

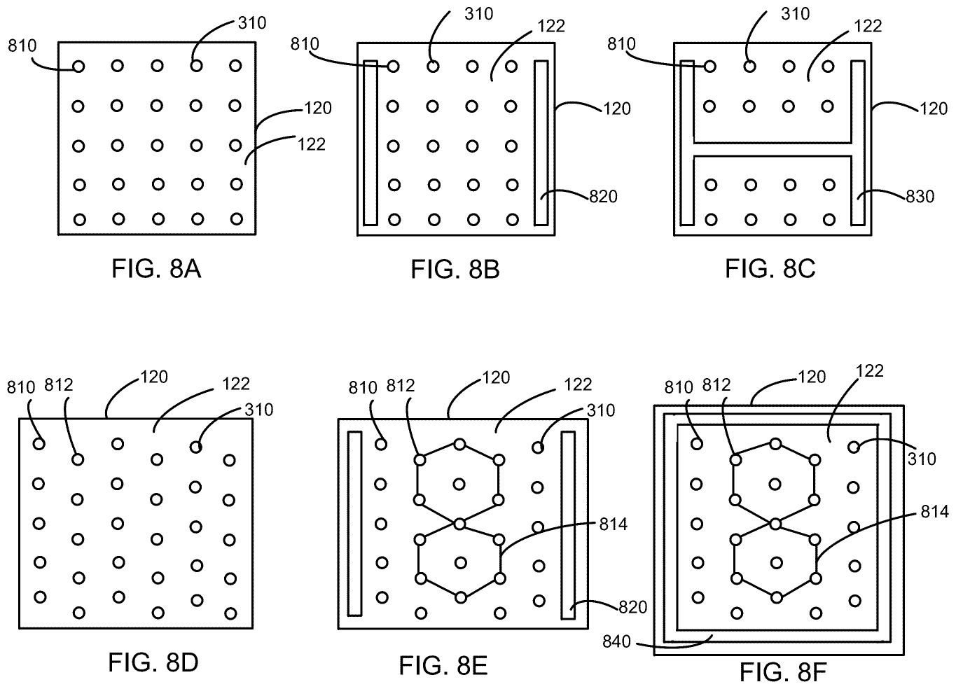

FIG. 8A through 8F illustrate top views of hole patterns for anode electrodes for batteries according to an embodiment of the present invention. In FIG. 8A, holes 310 can be formed in pattern of rows 810 in surface 122 of anode electrode 120. Horizontal rows 810 can be aligned in vertical columns (as drawn.) In this example, each hole 310 is shown as being the same size, though different sized pins 432 can be used to form different sized holes 310 in these and other embodiments of the present invention. Holes 310 can each have the same depth, though some holes 310 can be deeper or shallower than other holes 310. While holes 310 in rows 810 can align with each other, they can have different spatial relationships. A pattern of rows 810 can be employed over a portion of anode electrode 120, while other patterns can be used in different portions of anode electrode 120, as shown in the following examples.

In FIG. 8B, holes 310 can be formed in pattern of rows 810 in surface 122 of anode electrode 120. Horizontal rows 810 can be aligned in vertical columns (as drawn.) In this example, each hole 310 is shown as being the same size, though different sized pins 432 can be used to form different sized holes 310 in these and other embodiments of the present invention. Holes 310 can each have the same depth, though some holes 310 can be deeper or shallower than other holes 310. While holes 310 in rows 810 can align with each other, they can have different spatial relationships. Also, a pattern of rows 810 can be employed over a portion of anode electrode 120, while other patterns can be used in different portions of anode electrode 120. In this example, one or more lines or slots 820 can be formed in surface 122 of anode electrode 120. Slots 820 can have a similar depth as holes 310, though slots 820 can be deeper or shallower as compared to holes 310.

In FIG. 8C, holes 310 can be formed in pattern of rows 810 in surface 122 of anode electrode 120. Horizontal rows 810 can be aligned in vertical columns (as drawn.) In this example, each hole 310 is shown as being the same size, though different sized pins 432 can be used to form different sized holes 310 in these and other embodiments of the present invention. Holes 310 can each have the same depth, though some holes 310 can be deeper or shallower than other holes 310. While holes 310 in rows 810 can align with each other, they can have different spatial relationships. Also, a pattern of rows 810 can be employed over a portion of anode electrode 120, while other patterns can be used in different portions of anode electrode 120. In this example, one or more joined lines or joined slots 830 can be formed in surface 122 of anode electrode 120, in this example forming an “H” shape. Joined slots 830 can have a similar depth as holes 310, though joined slots 830 can be deeper or shallower as compared to holes 310.

In FIG. 8D, holes 310 can be formed in pattern of rows 810 and rows 812 in surface 122 of anode electrode 120. Horizontal rows 810 and horizonal rows 812 can both be aligned in vertical columns (as drawn.) In this example, each row 812 can be offset vertically by one-half a spacing between adjacent rows 810. In this example, each hole 310 is shown as being the same size, though different sized pins 432 can be used to form different sized holes 310 in these and other embodiments of the present invention. Holes 310 can each have the same depth, though some holes 310 can be deeper or shallower than other holes 310. A pattern of rows 810 and rows 812 can be employed over a portion of anode electrode 120, while other patterns can be used in different portions of anode electrode 120.

In FIG. 8E, holes 310 can be formed in pattern of rows 810 and rows 812 in surface 122 of anode electrode 120. Horizontal rows 810 and horizonal rows 812 can both be aligned in vertical columns (as drawn.) In this example, each row 812 can be offset vertically by one-half a spacing between adjacent rows 810. In this example, each hole 310 is shown as being the same size, though different sized pins 432 can be used to form different sized holes 310 in these and other embodiments of the present invention. Holes 310 can each have the same depth, though some holes 310 can be deeper or shallower than other holes 310. A pattern of rows 810 and rows 812 can be employed over a portion of anode electrode 120, while other patterns can be used in different portions of anode electrode 120. In this example, one or more lines or slots 820 can be formed in surface 122 of anode electrode 120. Slots 820 can have a similar depth as holes 310, though slots 820 can be deeper or shallower as compared to holes 310. One or more hexagonal patterns 814 can be formed, each connecting six holes 310, though other patterns involving different numbers of holes 310 can be formed.

In FIG. 8F, holes 310 can be formed in pattern of rows 810 and rows 812 in surface 122 of anode electrode 120. Horizontal rows 810 and horizonal rows 812 can both be aligned in vertical columns (as drawn.) In this example, each row 812 can be offset vertically by one-half a spacing between adjacent rows 810. In this example, each hole 310 is shown as being the same size, though different sized pins 432 can be used to form different sized holes 310 in these and other embodiments of the present invention. Holes 310 can each have the same depth, though some holes 310 can be deeper or shallower than other holes 310. A pattern of rows 810 and rows 812 can be employed over a portion of anode electrode 120, while other patterns can be used in different portions of anode electrode 120. In this example, one or more joined lines or joined slots 840 can be formed in surface 122 of anode electrode 120, in this example forming a rectangular boundary shape. Joined slots 840 can have a similar depth as holes 310, though joined slots 840 can be deeper or shallower as compared to holes 310. One or more hexagonal patterns 814 can be formed, each connecting six holes 310, though other patterns involving different numbers of holes 310 can be formed.

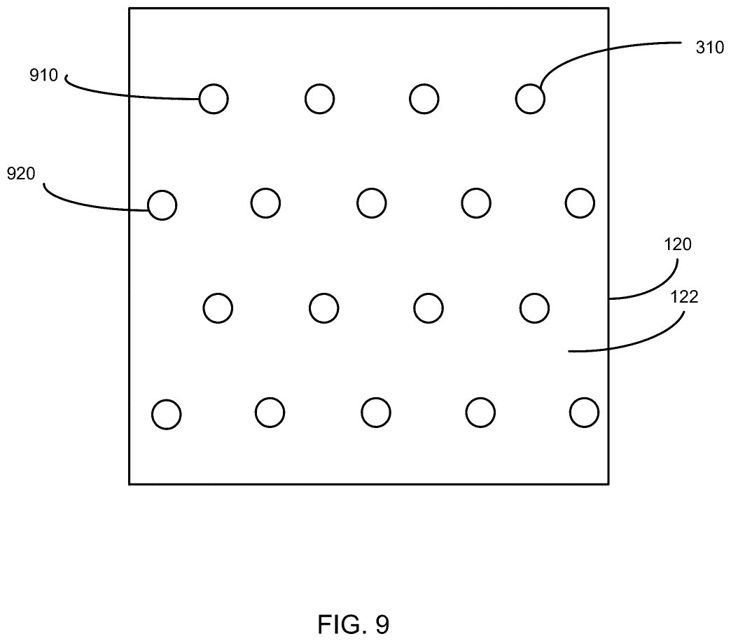

FIG. 9 illustrates a top view of another hole pattern for an anode electrode for a battery according to an embodiment of the present invention. Holes 310 can be formed in a pattern of rows 910 and rows 920 in surface 122 of anode electrode 120. Rows 910 and rows 920 can be vertically offset from each other (as drawn.) In this example, each hole 310 is shown as being the same size, though different sized pins 432 can be used to form different sized holes 310 in these and other embodiments of the present invention. Also, a pattern of rows 910 and rows 920 can be employed over a portion of anode electrode 120, while other patterns can be used in different portions of anode electrode 120. While surface 122 can include holes 310 having a circular cross-section, other shapes having other cross-sections can be used. An example is shown in the following figure.

FIG. 10 illustrates a top view of another hole pattern for an anode electrode for a battery according to an embodiment of the present invention. Holes 310 can be formed in a pattern of rows 910 and rows 920 in surface 122 of anode electrode 120. Rows 910 and rows 920 can be vertically offset from each other (as drawn.) In this example, each hole 310 is shown as being the same size, though different sized pins 432 can be used to form different sized holes 310 in these and other embodiments of the present invention. Holes 310 are shown as having circular cross-section. Holes having other shapes, such as line-shaped hole 1010 can be included in surface 122 of anode electrode 120. A pattern of rows 910, rows 920, and line-shaped hole 1010 can be employed over a portion of anode electrode 120, while other patterns can be used in different portions of anode electrode 120.

FIG. 11 illustrates a system for forming holes in a top and bottom of an anode electrode structure for a battery according to an embodiment of the present invention. System 1100 can include roller 433. Roller 433 can guide anode electrode structure 1110 and pass it to cylinder 430 and roller 434. Cylinder 430 can have a number of pins 432 and other shaped protrusions extending from its surface. Pins 432 can form holes 310 or other depressions in surfaces 122 of anode electrodes 120. Anode electrodes 120 can be supported by anode current collector 110 to form anode electrode structure 1110.

In these and other embodiments of the present invention, anode electrode structure 1110 can be received from calender 410 (shown in FIG. 4) by roller 433 and passed to cylinder 430 and roller 434. Holes 310a can be formed in a first top surface 122a of anode electrode 120a by pins 432 on cylinder 430. Anode electrode structure 1110 can then be flipped into the illustrated position and guided again by roller 433 and passed to roller 434 and cylinder 430.

Holes 310b can be formed in a second top surface 122b of anode electrode 120b. Anode electrode structure 1110 can pass from left to right (as drawn) and holes 310b can be formed by pins 432.

After holes 310 have been formed in a surfaces of anode electrodes 120, a protective layer can be deposited on surfaces 122 and in holes 310. This protective layer can be formed of aluminum oxide or other material. The protective layer can be formed using atomic layer deposition. For example, the protective layer can be formed using spatial atomic layer deposition. The protective layer can help to prevent plating of the electrode material during use in a battery. That is, the protective layer can help to prevent the formation of a solid electrolyte interphase (SEI) layer on the electrode material, which could otherwise irreversibly consume lithium ions. The protective layer can further help to reduce the pulverization of individual graphite particles in the electrode material caused by volume changes due to lithium ion insertion and extraction during use in a battery. The protective layer can further reduce dendrite growth from the anode and can reduce particle cracking as well. This or a similar protective layer can be formed on a surface of the cathode as well. This cathode protective layer can also help to prevent particle cracking in the cathode and can reduce structural disorder in the cathode. The cathode protective layer can also help to inhibit transition metal dissolution and pulverization.

In this example, holes 310 are shown as being formed by pins 432 of cylinder 430. In these and other embodiments of the present invention, other devices, such as a laser, can be used to form additional holes 310 or other depressions having other shapes. For example, a laser can be used to form lines as shown above in FIG. 10. One or more lasers can be used to form other shaped depressions, such as plus signs, X shaped depressions, or other shaped holes or depressions. Also, while these embodiments are particularly well-suited to increasing a surface area of an anode electrode, these and other embodiments of the present invention can be used to increase surface areas of cathodes or other battery structures.

In this configuration, holes 310a are formed during a first pass of anode electrode structure 1110 through roller 434 and cylinder 430. Once holes 310a are formed, anode electrode structure 1110 is flipped and passed through roller 434 and cylinder 430 again. This can generate a compression force on holes that can tend to reduce the width W of the opening in holes 310a. An example is shown in the following figure.

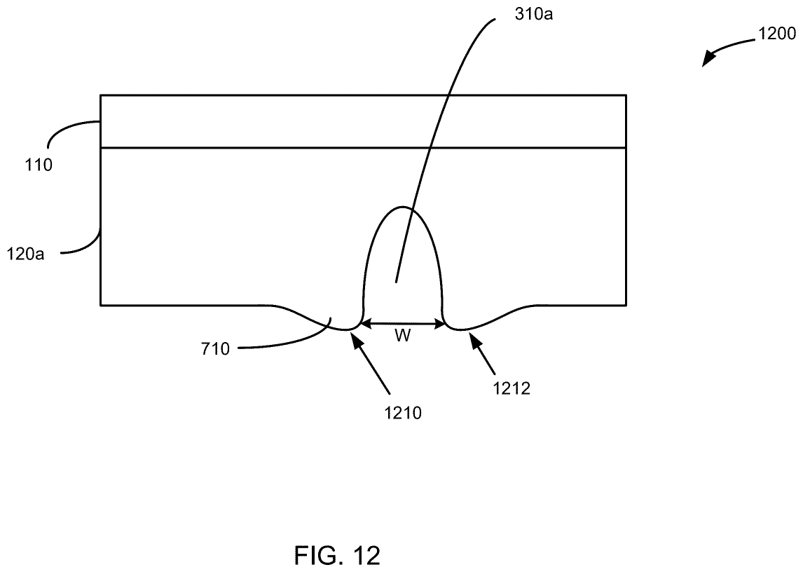

FIG. 12 illustrates compression forces being applied to a hole in an anode electrode for a battery according to an embodiment of the present invention. Once holes 310a are formed in the system 1100 (shown in FIG. 11), anode electrode structure 1110 (id.) can pass through roller 434 and cylinder 430 (id.) again. Roller 434 can apply force, shown here as 1210 and 1212, to material 710 around the opening of hole 310a. This can act to push material 710 back into hole 310a. Once holes 310 have been formed in both anode electrodes 120 of anode electrode structure 1110, holes 310a can have smaller openings than holes 310b. An example is shown in the following figure.

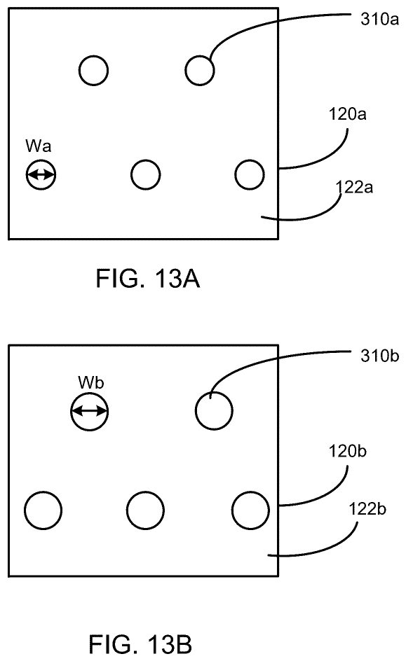

FIG. 13A and FIG. 13B are top views of a comparison of holes in a top and holes in a bottom of an anode electrode for a battery according to an embodiment of the present invention. In FIG. 13A, holes 310a can be formed in surface 122a of anode electrode 120a. In FIG. 13B, holes 310b can be formed in surface 122b of anode electrode 120b. Holes 310a in anode electrode 120a can have an opening with a width Wa. Holes 310b in anode electrode 120b can have an opening with a width Wb. Width Wb can be wider and width Wa. That is, holes 310a can be narrowed or partially closed by passing through roller 434 and cylinder 430 an extra time as shown in FIG. 12. While holes 310a can become narrowed due to roller 434 and cylinder 430 pushing material 710 back into hole 310a, holes 310a and 310b can both act to increase a surface area of anode electrode 120a and anode electrode 12b. This is shown in the following figure.

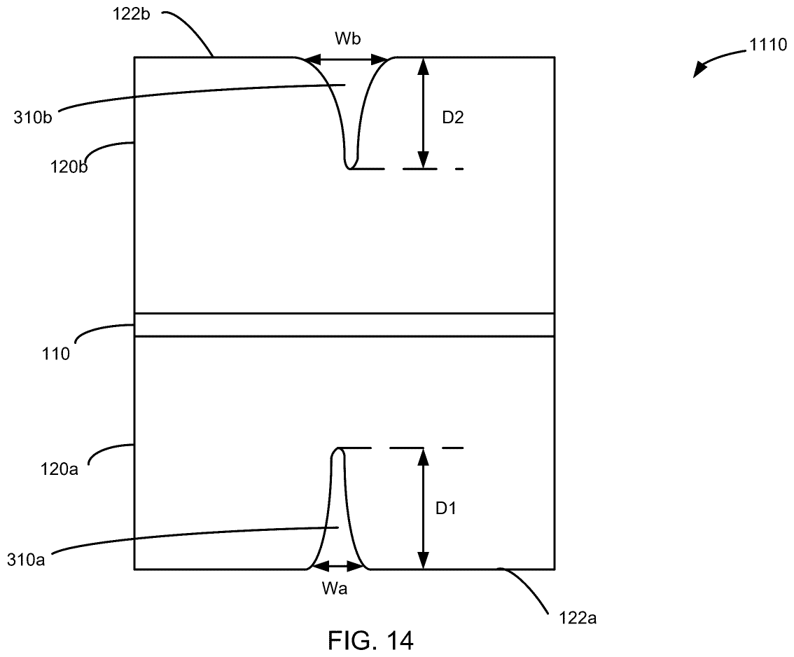

FIG. 14 is a side view of a comparison of holes in a top and holes in a bottom of an anode electrode for a battery according to an embodiment of the present invention. Holes 310a can be formed in surface 122a of anode electrode 120a. Holes 310b can be formed in surface 122b of anode electrode 120b. Holes 310a in anode electrode 120a can have an opening with a width Wa. Holes 310b in anode electrode 120b can have an opening with a width Wb. Width Wb can be wider and width Wa. That is, holes 310a can be narrowed or partially closed by passing through roller 434 and cylinder 430 a second time as shown in FIG. 12. While holes 310a can become narrowed due to roller 434 and cylinder 430 pushing material 710 back into hole 310a, holes 310a can maintain a sufficient width to provide an increase in a surface area of anode electrode 120a.

Again, increasing the surface area using holes 310 can provide several benefits. Mechanically forming holes 310 allows a greater density of holes to be provide in anode electrode 120 as compared to other methods, such as using a laser. For example, mechanically forming holes 310 with pins 432 on cylinder 430 can provide an area of an anode electrode 120 having a pitch of approximately 100 microns. Using a laser can cause local heating of an anode electrode 120, thereby limiting a pitch of holes to approximately 300 microns. The increase in the number of holes 310 using a mechanical method can help to improve battery capacity and other parameters. For example, a capacity of a battery with holes at a 100 micron pitch can remain higher than a capacity of a battery with holes at a 300 micron pitch. Also, the amount of electrode material can remain higher since lasers can vaporize electrode material during hole formation. The increase surface area gained using a mechanical method can reduce heat loss and other effects that can improve capacity as compared to using a laser. An example is shown in the following figure.

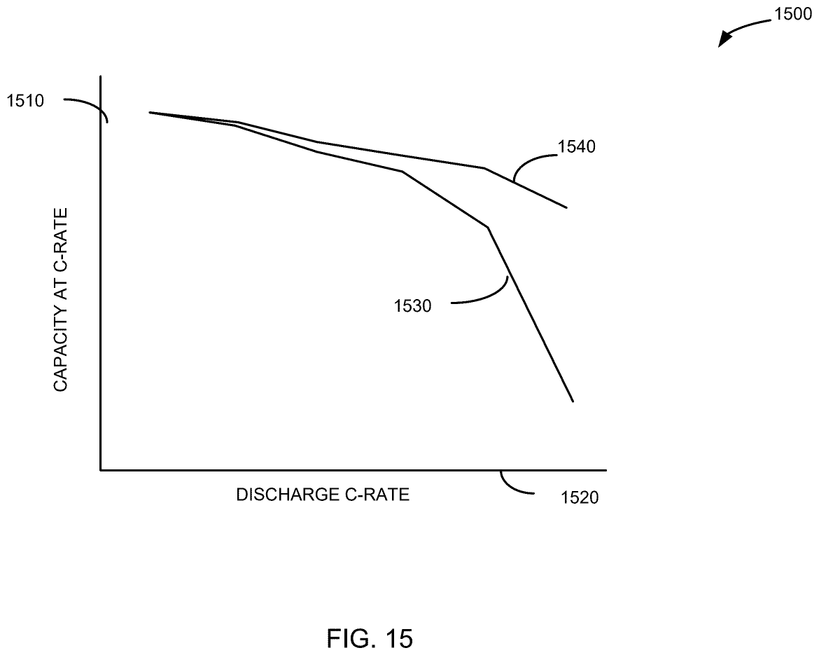

FIG. 15 illustrates an improvement in capacity as a function of discharge current for a battery formed according to an embodiment of the present invention. In graph 1500, capacity 1510 is plotted as a function of discharge rate 1520. In a battery where fewer holes are formed using a laser, the capacity 1530 can quickly fall off with discharge rate. In a battery where more holes are formed mechanically, the capacity 1540 can remain high even at a high discharge rate. The mechanical method can be the method shown in FIG. 4 and FIG. 11, where holes are formed with a pitch of approximately 100 microns. The battery where holes are formed with a laser can have holes at a larger pitch of approximately 300 microns or more. Also, the use of a laser can vaporize a few percent of the electrode material, further reducing capacity.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

1. A battery comprising:
a first current collector;
a first anode electrode having a bottom surface formed on a first side of the first current collector, wherein a top surface of the first anode electrode comprises a plurality of holes in a region, the plurality of holes in the region having a pitch less than 200 microns;
a second anode electrode having a top surface formed on a second side of the first current collector;
a second current collector;
a first cathode electrode having a bottom surface formed on a first side of the second current collector;
a second cathode electrode having a top surface formed on a second side of the second current collector; and
a separator between the bottom surface of the second anode electrode and the top surface of the first cathode electrode.

2. The battery of claim 1 wherein the plurality of holes in the region have a pitch less than 150 microns.

3. The battery of claim 1 wherein the plurality of holes in the region have a pitch less than 100 microns.

4. The battery of claim 1 wherein the plurality of holes are formed mechanically.

5. The battery of claim 4 wherein the plurality of holes are formed using a plurality of pins formed on a surface of a cylinder.

6. The battery of claim 1 further comprising a protective layer deposited on the top surface of the first anode electrode and in the plurality of holes.

7. The battery of claim 6 wherein the protective layer is formed of aluminum oxide.

8. The battery of claim 6 wherein the protective layer is formed using atomic layer deposition.

9-14. (canceled)

15. A battery comprising:
a first current collector;
a first anode electrode having a bottom surface formed on a first side of the first current collector, wherein a top surface of the first anode electrode comprises a first plurality of holes;
a second anode electrode having a top surface formed on a second side of the first current collector, wherein a bottom surface of the second anode electrode comprises a second plurality of holes;
a second current collector;
a first cathode electrode having a bottom surface formed on a first side of the second current collector;
a second cathode electrode having a top surface formed on a second side of the second current collector; and
a separator between the bottom surface of the second anode electrode and the top surface of the first cathode electrode.

16. The battery of claim 15 wherein the first plurality of holes and the second plurality of holes are formed mechanically using a plurality of pins formed on a surface of a cylinder.

17. The battery of claim 15 wherein the second plurality of holes have an average opening that is at least 5 percent larger than an average opening of the first plurality of holes.

18. The battery of claim 16 wherein the cylinder is used to form the first plurality of holes and then the cylinder is used to form the second plurality of holes.

19. A method of manufacturing a battery, the method comprising:
providing an anode current collector;
forming a layer of electrode material on the anode current collector such that the layer of electrode material has a bottom surface adjacent to the anode current collector and a top surface opposite the bottom surface;
drying the layer of electrode material;
calendering the layer of electrode material and the anode current collector; and
using mechanical force to form a first plurality of holes in the top surface of the layer of electrode material.

20. The method of claim 19 wherein the mechanical force is provided by a plurality of pins formed on a surface of a cylinder.

21. The method of claim 19 wherein the layer of electrode material forms an anode electrode for a battery.

22. The method of claim 21 wherein the anode electrode comprises graphite.

23. The method of claim 19 further comprising using a laser to form a second plurality of holes in the top surface of the layer of electrode material.

24. The method of claim 19 further comprising a protective layer deposited on the top surface of the layer of electrode material and in the first plurality of holes.

25. The method of claim 24 wherein the protective layer is formed of aluminum oxide.

26. The method of claim 24 wherein the protective layer is formed using atomic layer deposition.
